(19) United States
(12) Patent Application Publication
(10) Pub. No.: US 2022/0089172 A1
(43) Pub. Date: Mar. 24, 2022

(54) Method and System for On-Board Diagnosis in a Vehicle

(71) Applicant: Bayerische Motoren Werke Aktiengesellschaft, Muenchen (DE)

(72) Inventors: Andrea ANTHOLZNER, Barnt Green (GB); Daniela CALINSKI, Karlsfeld (DE)

(21) Appl. No.: 17/425,468

(22) PCT Filed: Feb. 12, 2020
(86) PCT No.: PCT/EP2020/053517

§ 371 Date: Jul. 23, 2021

(30) Foreign Application Priority Data
Mar. 18, 2019 (DE) 10 2019 106 771.5

(51) Int. Cl. B60W 50/08; B60W 50/02; B60W 50/04

(52) U.S. Cl. CPC B60W 50/087; B60W 50/0205; B60W 50/04; B60W 2540/103; B60W 2710/0644; B60W 2710/0666; B60W 2050/041

(57) ABSTRACT

A method for on-board diagnosis in a vehicle includes a) determining whether one or more release conditions for starting an on-board diagnosis are met; b) when it is determined that at least one release condition of the one or more release conditions is not met, controlling at least one driving function in such a manner that at least one release condition is met; and c) starting the on-board diagnosis.

### BACKGROUND AND SUMMARY OF THE INVENTION

The present disclosure relates to a method and a system for onboard diagnosis (OBD) in a vehicle, in particular a motor vehicle. The present disclosure relates in particular to the improved coverage of a real driving behavior to carry out onboard diagnoses, for example, of exhaust-gas-influencing systems or subsystems in vehicles.

Onboard diagnoses (OBD) are used in vehicles to monitor (sub)systems and components during the driving operation, for example, exhaust-gas-influencing systems. The onboard diagnoses can, for example, recognize malfunctions early which result in abnormal states in the engine.

In onboard diagnosis, analyses are repeatedly carried out, in which complex physical relationships can be depicted by algorithms. Each of these analyses requires certain conditions, under which they function reliably. Fixed release conditions can be derived from these conditions, which specify from when an analysis may begin in the vehicle. The release conditions can be oriented to the respective vehicle and/or to an average driving behavior of the vehicle owner. The parameterization can be defined once per vehicle type and no longer changes from then on.

The driving behavior of the vehicle owner generally represents a Gaussian curve in its frequency. If the limits for the release of the onboard diagnosis are set too narrowly, only a small central region of the driving behavior is covered in the Gaussian curve. However, some lawmakers require at least a coverage of 36%. A conflict now lies here between safeguarding the physical requirements of the onboard diagnosis and adequate coverage of the driving behavior.

It is an object of the present disclosure to provide an improved coverage of a real driving behavior to carry out onboard diagnoses. In particular, it is an object of the present disclosure to facilitate carrying out onboard diagnoses and/or enable them to be carried out more frequently.

This object is achieved by the claimed invention.

According to one independent aspect of the present disclosure, a method for onboard diagnosis in a vehicle, in particular a motor vehicle, is specified. The method comprises:
a) determining whether one or more release conditions for a start of an onboard diagnosis are fulfilled;
b) if it is determined that at least one release condition of the one or more release conditions is not fulfilled:
   controlling at least one vehicle function in such a way that the at least one release condition is fulfilled; and
c) starting the onboard diagnosis.

If it is determined in step b) that all release conditions are fulfilled, the onboard diagnosis can begin immediately.

According to embodiments of the invention, an active intervention is made in the driving behavior of the driver when the release conditions can be achieved by controlling or regulating at least one vehicle function, for example, a simple regulation of the engine status. For example, if a driver drives on a freeway at high load and/or high speed, throttling can be carried out by an active intervention of the onboard diagnosis, for example, to set an operating point of the engine which is required for the release condition(s). Therefore, a driver who could fulfill the condition for the release, but does not achieve it because of his (unusual) behavior, can “artificially” be made into such a driver. The intervention can remain in existence as long as it is required for the onboard diagnosis. A greater range of the driver behavior can be covered in this way. Moreover, carrying out onboard diagnoses can be facilitated and/or can be made possible more frequently.

The onboard diagnosis to be carried out can be any diagnosis which is carried out during a journey. In particular, in general a plurality of onboard diagnoses are provided in vehicles, which are carried out continuously or discontinuously. The present disclosure is not restricted to a specific onboard diagnosis and can be applied with any onboard diagnoses, the release conditions of which can be achieved by controlling the at least one vehicle function.

For the onboard diagnosis, it has to be ensured that it can be carried out during the journey. For example, in the case of exhaust-gas-relevant components, firstly specific operating states have to be achieved to be able to carry out an onboard diagnosis. For this purpose, the one or the multiple release conditions are defined, which specify from when the onboard diagnosis can or may start. A plurality of different onboard diagnoses can be carried out in the vehicle, wherein an individual set of release conditions can be defined for each onboard diagnosis of the plurality of onboard diagnoses.

In the context of the present document, release conditions are observed which can be fulfilled by the control of the at least one vehicle function, for example a regulation of the engine status. For example, an onboard diagnosis can only be reasonably carried out in a defined speed range of the engine. The defined speed range can be specified by a corresponding release condition. According to the embodiments of the present disclosure, the engine control can be carried out in such a way that the speed of the engine is within the defined speed range in order to fulfill the release condition(s) for the onboard diagnosis. Moreover, the engine control can take place while the onboard diagnosis is carried out in such a way that the speed of the engine remains within the defined speed range. The engine can be, for example, an internal combustion engine, such as a diesel engine or a gasoline engine.

However, the release conditions are not restricted to speeds and can affect any systems or subsystems, and in particular exhaust-gas-influencing systems or subsystems of the vehicle. The release conditions can relate, for example, to temperatures (e.g., an exhaust gas temperature, coolant temperature, etc.), pressures (e.g., a system air pressure, exhaust gas pressure, etc.), and operating points (e.g., speed, torque, etc.), but are not restricted thereto. The release conditions are selected suitably and established in accordance with the onboard diagnosis to be carried out.

According to the present disclosure, at least one vehicle function is controlled which is suitable so that by the regulation thereof, the at least one release condition can be fulfilled for the onboard diagnosis to be carried out. The at least one vehicle function can affect exhaust-gas-influencing systems of the vehicle, and in particular an engine of the vehicle. The engine can be an internal combustion engine, for example, but is not restricted thereto. For example, the release conditions required for carrying out the onboard diagnosis can be achieved by a regulation of the engine status (e.g., speed, torque, turbocharger speed, traction, thrust, etc.).

The control of the at least one vehicle function preferably comprises a setting or regulation of at least one operating point of the engine of the vehicle in such a way that the at least one release condition is fulfilled. The at least one operating point can comprise or affect, for example, a speed and/or a torque and/or an accelerator pedal position of the engine. For example, a corresponding release condition for a specific onboard diagnosis to be carried out can be fulfilled by a setting of a speed and/or load of the engine.

The control of the at least one vehicle function preferably comprises a reception of input data which specify an accelerator pedal position or an accelerator pedal actuation by a driver; and a processing of the input data for the engine control in such a way that the at least one release condition is fulfilled based on the engine control. For example, an interpretation of the accelerator pedal position can be carried out in software in such a way that the at least one release condition is fulfilled.

In some embodiments, the processing of the input data for the engine control can comprise, for example, a compensation of accelerator pedal actuations by the driver which exceed a threshold. In particular, excessive and/or unnecessary actuations of the accelerator pedal can be compensated for in software. For example, “pumping” of the accelerator pedal by the driver, which has little or no influence on the actual driving behavior of the vehicle (for example, an actual acceleration), can be compensated for. For this purpose, the engine control can be carried out in such a way, for example, that in spite of the “pumping” of the accelerator pedal, an excessive increase of the speed of the engine does not take place. In particular, the actual speed or the target value for the speed output by the engine controller can be suitable for carrying out the onboard diagnosis in spite of the “pumping” of the accelerator pedal by the driver and can fulfill the corresponding release condition.

Preferably, the method furthermore comprises ending the onboard diagnosis and controlling the at least one vehicle function in such a way that the at least one release condition is fulfilled after the the onboard diagnosis is completely carried out. In other words, the active intervention in the driving behavior can only take place as long as is necessary for carrying out the onboard diagnosis.

Preferably, the control of the at least one vehicle function to fulfill the at least one release condition takes place in such a way that a change of a driving behavior of the vehicle is below a perception threshold for the driver. For example, “pumping” of the accelerator pedal by the driver can be compensated enough that it has little or no influence on an actual acceleration of the vehicle.

According to a further independent aspect, a software (SW) program is specified. The SW program can be configured to be executed on one or more processors, and in order to thus execute the method described in this document for onboard diagnosis in a vehicle.

According to a further independent aspect, a storage medium is specified. The storage medium can comprise an SW program, which is configured to be executed on one or more processors, and to thus execute the method described in this document for onboard diagnosis in a vehicle.

According to a further independent aspect, a system for onboard diagnosis in a vehicle is specified. The system comprises one or more processors which are configured to thus execute the method described in this document for onboard diagnosis in a vehicle.

Preferably, the system comprises the storage medium having the SW program.

According to a further independent aspect of the present disclosure, a vehicle is specified, comprising the system described in this document for onboard diagnosis. The term vehicle comprises passenger vehicles, trucks, buses, caravans, motorcycles, etc., which are used for conveying persons, goods, etc. In particular, the term comprises motor vehicles for personal conveyance.

Exemplary embodiments of the disclosure are illustrated in the FIGURE and are described in greater detail hereinafter.

### BRIEF DESCRIPTION OF THE DRAWING

FIG. 1 shows a flow chart of a method for onboard diagnosis in a vehicle according to embodiments of the present disclosure.

### DETAILED DESCRIPTION OF THE DRAWING

In the following, identical reference signs are used for identical and identically acting elements if not indicated otherwise.

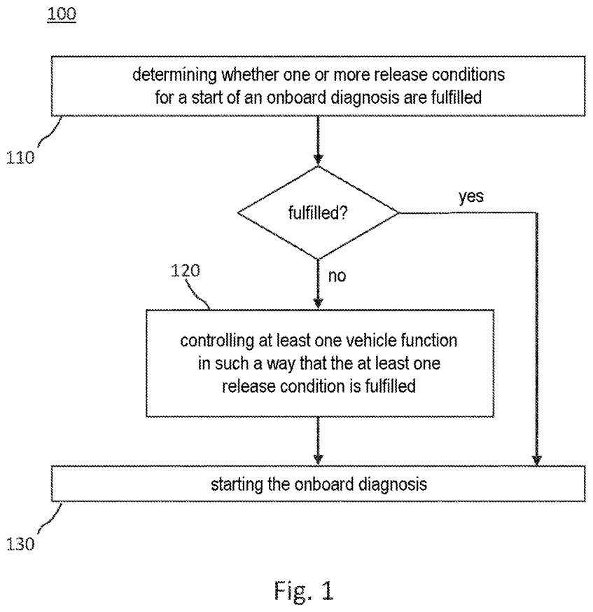

FIG. 1 shows a flow chart of a method 100 for onboard diagnosis in a vehicle, in particular a motor vehicle, according to embodiments of the present disclosure.

The method 100 comprises in block 110 a determination as to whether one or more release conditions are fulfilled for a start of an onboard diagnosis. If it is determined in block 110 that all release conditions for the start of the onboard diagnosis are fulfilled, the onboard diagnosis is started in block 130.

However, if it is determined in block 110 that at least one release condition of the release conditions required for the start of the onboard diagnosis is not fulfilled, a control of at least one vehicle function takes place in block 120 in such a way that the at least one release condition is fulfilled. When the at least one release condition is fulfilled by the control or regulation of the at least one vehicle function, the onboard diagnosis can start in block 130.

The method 100 furthermore comprises ending the control of the at least one vehicle function in such a way that the at least one release condition is fulfilled after the onboard diagnosis is completely carried out. In other words, the active intervention in the driving behavior can only take place as long as is necessary to carry out the onboard diagnosis.

In some embodiments, the control of the at least one vehicle function to fulfill the at least one release condition takes place in such a way that a change of a driving behavior of the vehicle is below a perception threshold for the driver. A negative influence of the onboard diagnosis on the driving experience can thus be prevented.

The driving behavior can be, for example, an acceleration of the vehicle. For example, if the driver rapidly moves or pumps the accelerator pedal, this can have little or no influence on the actual acceleration of the vehicle due to inertia. Nonetheless, the speed of the engine can briefly vary strongly. This variation of the speed can be avoided by the engine control, even if the driver “pumps”, so that a release condition relating to the speed of the engine is fulfilled and the onboard diagnosis can be carried out.

According to the present disclosure, at least one vehicle function is actively controlled which is suitable so that by the regulation thereof, the at least one release condition for the onboard diagnosis to be carried out can be fulfilled. The at least one vehicle function can affect exhaust-gas-influencing systems of the vehicle and in particular an engine of the vehicle. The engine can be, for example, an internal combustion engine, such as a diesel engine or gasoline engine.

However, the present disclosure is not restricted to vehicles having an internal combustion engine and can be used in onboard diagnoses in vehicles having an electric motor. In particular, the vehicle can be a vehicle having only an internal combustion engine, a purely electric vehicle, or a hybrid vehicle.

In some embodiments, the control of the at least one vehicle function comprises setting or regulating at least one operating point of the engine of the vehicle in such a way that the at least one release condition is fulfilled. The at least one operating point can comprise or be, for example, a speed and/or a torque of the engine. For example, by setting a speed and/or load of the engine, a corresponding release condition can be fulfilled for a specific onboard diagnosis to be carried out.

In some embodiments, the control of the at least one vehicle function comprises receiving input data, which specify an accelerator pedal position or an accelerator pedal actuation by a driver, and processing the input data for the engine control in such a way that the at least one release condition is fulfilled based on the engine control. For example, an interpretation of the accelerator pedal position can be carried out in software in such a way that the at least one release condition is fulfilled in the course of the engine control.

The processing of the input data for the engine control can typically comprise, for example, compensating for accelerator pedal actuations by the driver which exceed a threshold. In particular, excessive and/or unnecessary actuations of the accelerator pedal can be compensated for or “smoothed” in software.

For example, rapid repeated actuation or “pumping” of the accelerator pedal by the driver can be compensated for. For this purpose, the engine control can be carried out, for example, in such a way that in spite of the “pumping” of the accelerator pedal, an excessive increase of the speed of the engine does not take place. In particular, the actual speed or the target value output by the engine controller for the speed can be suitable for carrying out the onboard diagnosis and can fulfill the corresponding release condition, in spite of the “pumping” of the accelerator pedal by the driver. This can take place in particular in such a way that no or only minor influence occurs on the actual driving behavior of the vehicle, for example an actual acceleration.

According to embodiments of the invention, an active intervention is made in the driving behavior of the driver when the release conditions can be achieved by controlling or regulating at least one vehicle function, for example, a simple regulation of the engine status. For example, if a driver drives on a freeway at high load and/or high speed, throttling can be carried out by an active intervention of the onboard diagnosis, for example, to set an operating point of the engine which is required for the release condition(s). Therefore, a driver who could fulfill the condition for the release, but does not achieve it because of his (unusual) behavior, can “artificially” be made into such a driver. The intervention can remain in existence as long as it is required for the onboard diagnosis. A greater range of the driver behavior can be covered in this way. Moreover, carrying out onboard diagnoses can be facilitated and/or can be made possible more frequently.

1.-10. (canceled)

11. A method for onboard diagnosis in a vehicle, the method comprising:
determining whether one or more release conditions for a start of an onboard diagnosis are fulfilled;
upon determining that at least one release condition of the one or more release conditions is not fulfilled, controlling at least one vehicle function in such a way that the at least one release condition is fulfilled; and
starting the onboard diagnosis.

12. The method according to claim 11, wherein the controlling of the at least one vehicle function comprises:
setting at least one operating point of an engine of the vehicle such that the at least one release condition is fulfilled.

13. The method according to claim 17, wherein the at least one operating point comprises at least one of a speed or a torque of an engine.

14. The method according to claim 11, wherein the controlling of the at least one vehicle function comprises:
receiving input data, which wherein the input data indicate an accelerator pedal actuation by a driver; and
processing the input data for engine control such that the at least one release condition is fulfilled based on the engine control.

15. The method according to claim 14, wherein the processing of the input data for the engine control comprises:
compensating for accelerator pedal actuations by the driver which exceed a threshold.

16. The method according to claim 11, further comprising:
ending the controlling of the at least one vehicle function such that the at least one release condition is fulfilled after the onboard diagnosis is carried out.

17. The method according to claim 11, wherein the controlling of the at least one vehicle function takes place such that a change of a driving behavior of the vehicle is below a perception threshold for a driver.

18. A computer program product comprising a non-transitory computer readable medium having stored thereon program code which, when executed on one or more processors, carries out the acts of:
determining whether one or more release conditions for a start of an onboard diagnosis are fulfilled;
upon determining that at least one release condition of the one or more release conditions is not fulfilled, controlling at least one vehicle function in such a way that the at least one release condition is fulfilled; and
starting the onboard diagnosis.

19. A system for onboard diagnosis in a vehicle, the system comprising one or more processors which are configured to execute a method comprising:
determining whether one or more release conditions for a start of an onboard diagnosis are fulfilled;
upon determining that at least one release condition of the one or more release conditions is not fulfilled, controlling at least one vehicle function in such a way that the at least one release condition is fulfilled; and
starting the onboard diagnosis.

20. A vehicle comprising the system according to claim 19.

21. The vehicle according to claim 20, wherein the vehicle is a motor vehicle.
